(19) United States
(12) Patent Application Publication
(10) Pub. No.: US 2018/0218603 A1
(43) Pub. Date: Aug. 2, 2018

(54) VEHICLE INFORMATION DISPLAY SYSTEM AND METHOD FOR DISPLAYING VEHICLE INFORMATION

(71) Applicant: TOYOTA JIDOSHA KABUSHIKI KAISHA, Toyota-shi (JP)

(72) Inventors: Shinobu TORII, Toyota-shi (JP); Koichi MASAMURA, Toyota-shi (JP); Koji AIKAWA, Nagoya-shi (JP)

(73) Assignee: TOYOTA JIDOSHA KABUSHIKI KAISHA, Toyota-shi (JP)

(21) Appl. No.: 15/881,104

(22) Filed: Jan. 26, 2018

(30) Foreign Application Priority Data
Jan. 30, 2017 (JP) 2017-014071

(51) Int. Cl. G08G 1/0968; B60K 35/00; G01C 21/36; G06F 3/14

(52) U.S. Cl. CPC G08G 1/096861; B60K 35/00; G01C 21/365; B60K 2350/352; B60K 2350/962; B60K 2350/1068; B60K 2350/2052; G06F 3/1438

(57) ABSTRACT

A vehicle information display system includes a head-up display configured to show intersection information in a first display region located in a line of sight of a driver when a distance from a vehicle to the intersection is less than a predetermined threshold value and a display device configured to show the intersection information in a second display region when the distance from the vehicle to the intersection is greater than the predetermined threshold value. The display device is configured so that when the distance from the vehicle to the intersection reaches the predetermined threshold value, the display device moves display of the intersection information in the second display region to the first display region and moves out the display of the intersection information from the second display region.

### INCORPORATION BY REFERENCE

The disclosure of Japanese Patent Application No. 2017-014071 filed on Jan. 30, 2017, including the specification, drawings and abstract is incorporated herein by reference in its entirety.

### BACKGROUND OF THE INVENTION

The present invention relates to a vehicle information display system and a method for displaying vehicle information that show a driver of a vehicle intersection information when the vehicle is approaching an intersection.

Japanese Laid-Open Patent Publication No. 2009-250919 describes an example of a vehicle information display system. When the vehicle approaches an intersection, in addition to showing intersection information on the instrument panel, the vehicle information display system uses a laser irradiation device to form a display region that shows the intersection information in the usual line of sight of the driver. This allows the driver to acknowledge the intersection information by looking at the display formed by the laser irradiation device instead of looking at the instrument panel.

However, when the vehicle approaches the intersection and the driver looks at the intersection information shown on the instrument panel before looking at the intersection information shown in the line of sight of the driver, the driver may not look away from the instrument panel. In this case, the driver may continue to keep his or her eyes fixed to the display instead of looking toward the front of the vehicle. This will lower the operability of driving the vehicle.

### SUMMARY OF THE INVENTION

It is an object of the present invention to provide a vehicle information display system and a method for displaying vehicle information that show a driver intersection information while maintaining the operability of driving a vehicle when the vehicle is approaching an intersection.

A vehicle information display system that achieves the above object is configured to show a driver intersection information related to an intersection toward which a vehicle is heading. The vehicle information display system includes a head-up display configured to show the intersection information in a first display region located in a line of sight of the driver when a distance from the vehicle to the intersection is less than a predetermined threshold value. The vehicle information display system further includes a display device configured to show the intersection information in a second display region, which differs from the first display region, when the distance from the vehicle to the intersection is greater than the predetermined threshold value and until the distance reaches the predetermined threshold value. The display device is configured so that when the distance from the vehicle to the intersection reaches the predetermined threshold value, the display device moves display of the intersection information in the second display region to the first display region and moves out the display of the intersection information from the second display region.

A method for displaying vehicle information that achieves the above object shows a driver intersection information related to an intersection toward which a vehicle is heading. The method includes showing the intersection information in a first display region of a display device when a distance from the vehicle to the intersection is greater than a predetermined threshold value and until the distance reaches the predetermined threshold value. The method further includes moving out display of the intersection information from the first display region when the distance from the vehicle to the intersection reaches the predetermined threshold value by moving the display of the intersection information in the first display region to a second display region of a head-up display located in a line of sight of a driver. The method further includes showing the intersection information in the second display region when the distance from the vehicle to the intersection is less than the predetermined threshold value.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram showing the configuration of one embodiment of a vehicle information display system;

FIGS. 2A to 2C are diagrams of a head-up display and a meter device of the vehicle information display system illustrated in FIG. 1 that cooperate to show intersection information; and

FIG. 3 is a sequence chart showing the flow of information when the head-up display and the meter device of FIGS. 2A to 2C cooperate to show the intersection information.

### DETAILED DESCRIPTION OF THE PREFERRED EMBODIMENTS

A vehicle information display system of the present embodiment is a system that shows a driver intersection information related to intersections located between a departure point and a destination point in a traveling route of a vehicle that is set by a navigation device. In the vehicle information display system, when the vehicle is approaching an intersection, a head-up display and a meter device cooperate to show the intersection information in accordance with the remaining distance to the intersection. This allows the vehicle information display system to show the driver the intersection information while maintaining the operability of driving the vehicle when the vehicle is approaching the intersection.

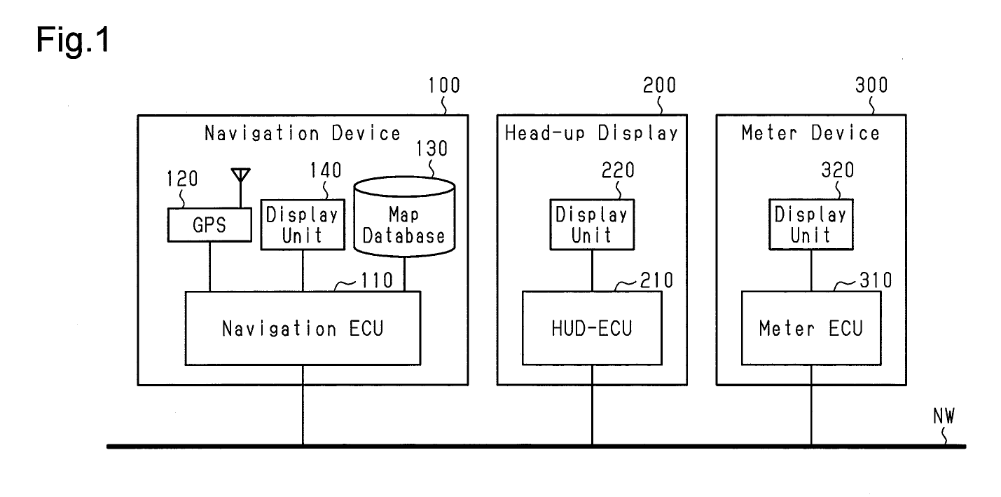

More specifically, as shown in FIG. 1, the vehicle information display system includes various electronic controllers that are connected to one another via a vehicle network NW such as a controller area network (CAN). The electronic controllers include a navigation ECU 110 of a navigation device 100 that controls route guidance of the vehicle, a HUD-ECU 210 of a head-up display 200 that controls images displayed in the line of sight of the driver, and a meter ECU 310 of a meter device 300 that calculates various parameters indicating the traveling state of the vehicle.

The navigation ECU 110 obtains information related to a vehicle position that is specified by a global positioning system 120 (GPS). Further, the navigation ECU 110 searches for a traveling route from the obtained vehicle position to a destination point using the Dijkstra's algorithm or the like while referring to map data registered in a map database 130. Among the intersections in the searched traveling route, the navigation ECU 110 reads intersection information from the map database 130 related to the intersection that is closest to the vehicle and located toward which the vehicle is heading. Further, the navigation ECU 110 sends the read intersection information to a display unit 140, which is formed by, for example, a liquid crystal display, and shows the read intersection information on the display unit 140. The intersection information assists driving at the intersection and includes, for example, information related to the traveling direction such as whether to turn left or right or go straight at the intersection, information related to the remaining distance to the intersection, and a guidance display image showing arrows used as guidance signs that indicate directions at the intersection. In addition, the navigation ECU 110 transmits the intersection information related to the intersection closest to the vehicle position on the traveling route via the vehicle network NW to the HUD-ECU 210 and the meter ECU 310 in predetermined cycles.

The HUD-ECU 210 receives intersection information from the navigation ECU 110 via the vehicle network NW. Further, the HUD-ECU 210 monitors whether or not the remaining distance to the next intersection included in the received intersection information has reached a predetermined threshold value. While the remaining distance to the next intersection is greater than the predetermined threshold value, the HUD-ECU 210 transmits a mask cancelation request to the meter ECU 310 via the vehicle network NW in order to request the meter ECU 310 to show the intersection information. Further, while the remaining distance to the next intersection is greater than the predetermined threshold value, the HUD-ECU 210 does not provide a display unit 220 with a guidance display image included in the intersection information received from the navigation ECU 110. At the point in time in which the remaining distance to the next intersection reaches the predetermined threshold value, the HUD-ECU 210 transmits a mask request to the meter ECU 310 via the vehicle network NW in order to request the meter ECU 310 to stop showing the intersection information. Further, at the point in time in which the remaining distance to the next intersection reaches the predetermined threshold value, the HUD-ECU 210 provides the display unit 220 with the guidance display image included in the intersection information received from the navigation ECU 110. The display unit 220 includes a light source that emits light in accordance with the guidance display image received from the HUD-ECU 210 and a combiner (display region) arranged on a windshield of the vehicle. The light source irradiates the combiner and reflects the image on the combiner. This forms a virtual image in the line of sight of the driver. That is, the display unit 220 shows a three-dimensional guidance display image by superimposing the scenery outside the vehicle on the display region of the head-up display 200 located in the line of sight of the driver.

The meter ECU 310 uses sensor values received from various sensors connected to the vehicle network NW to calculate the vehicle speed, the engine speed, and the like as parameters indicating the traveling state of the vehicle and sends the calculation result to a display unit 320, which is formed by, for example, a liquid display, to show the calculation result on the display unit 320. Further, in response to the mask request or the mask cancelation request received from the HUD-ECU 210 via the vehicle network NW, the meter ECU 310 switches the display of the guidance display image included in the intersection information received from the navigation ECU 110 via the vehicle network NW. More specifically, when receiving the mask cancelation request from the HUD-ECU 210, the meter ECU 310 provides the display unit 320 with the guidance display image included in the intersection information received from the navigation ECU 110 and shows the guidance display image on the display unit 320. When receiving the mask request from the HUD-ECU 210, the meter ECU 310 moves the guidance display image (display of intersection information) shown on the display unit 320 (display region of meter device 300) to the display region of the head-up display 200 and moves out the guidance display image on the display unit 320. Subsequently, when receiving the mask cancelation request from the HUD-ECU 210, the meter ECU 310 provides the display unit 320 with the guidance display image included in the intersection information received from the navigation ECU 110 and shows the guidance display image on the display unit 320. The guidance display image (display of intersection information) may be referred to as the object indicating the intersection information.

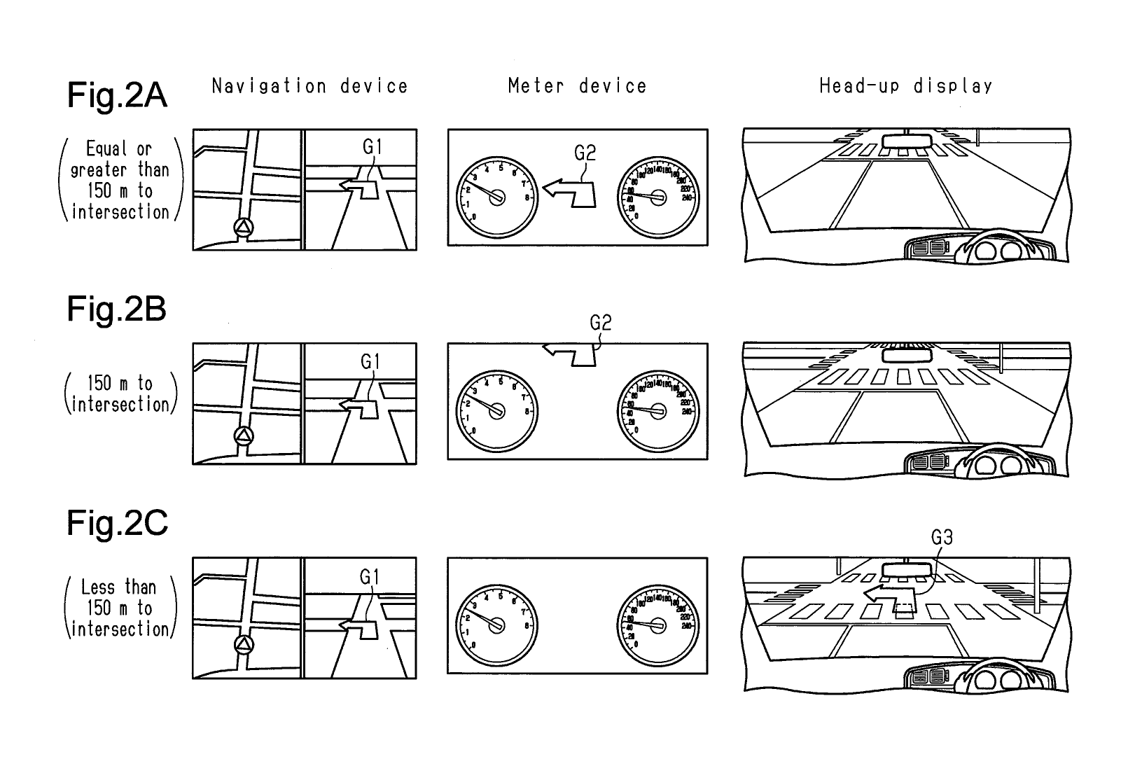

One example of a situation in which the meter device 300 and the head-up display 200 cooperate to show intersection information together with the intersection information of the navigation device 100 will now be described with reference to FIGS. 2A to 2C. In this example, the navigation device 100 shows the intersection information on a screen of a display unit 140 that is divided into two screens, namely, a left screen and a right screen. The left screen of the navigation device 100 shows a bird's-eye view of where the vehicle is located on the map data, and the right screen of the navigation device 100 shows a guidance display image G1 instructing the vehicle to turn left at the next intersection.

As shown in FIG. 2A, when the remaining distance to the intersection is greater than or equal to a predetermined threshold value (in this example, 150 m), the meter device 300 shows a guidance display image G2 that instructs the vehicle to turn left at the next intersection (first display process) in the central portion of the display unit 320. As shown in FIG. 2B, at the point in time in which the remaining distance to the intersection reaches the predetermined threshold value, the meter device 300 moves the guidance display image G2 to the head-up display 200 and moves out the guidance display image G2 from the display unit 320 (display movement process). In the present embodiment, the display region of the head-up display 200 is located above the display unit 320 of the meter device 300. Thus, at the point in time in which the remaining distance to the intersection reaches the predetermined threshold value, the meter device 300 upwardly moves the guidance display image G2 on the display unit 320 so that the guidance display image G2 moves out from the display unit 320. Subsequently, as shown in FIG. 2C, when the remaining distance to the intersection is less than the predetermined threshold value, the meter device 300 does not show the guidance display image G2 on the display unit 320.

Further, as shown in FIG. 2A, when the remaining distance to the intersection is greater than or equal to the predetermined threshold value, the head-up display 200 does not show the intersection information in the display region located in the line of sight of the driver. As shown in FIG. 2B, at the point in time in which the remaining distance to the intersection reaches the predetermined threshold value, the head-up display 200 does not show the intersection information in the display region, which is located in the line of sight of the driver. As shown in FIG. 2C, when the remaining distance to the intersection is less than the predetermined threshold value, the head-up display 200 shows a guidance display image G3 that instructs the driver to turn the vehicle left at the next intersection in the display region, which is located in the line of sight of the driver (second display process). More specifically, when the remaining distance to the intersection is less than the predetermined threshold value and the guidance display image G2 has moved out from the display unit 320 of the meter device 300, the head-up display 200 shows the guidance display image G3 in the display region, which is located in the line of sight of the driver.

The operation of the vehicle information display system of the present embodiment, in particular, the display operation of intersection information performed through cooperation of the HUD-ECU 210 and the meter ECU 310 will now be described.

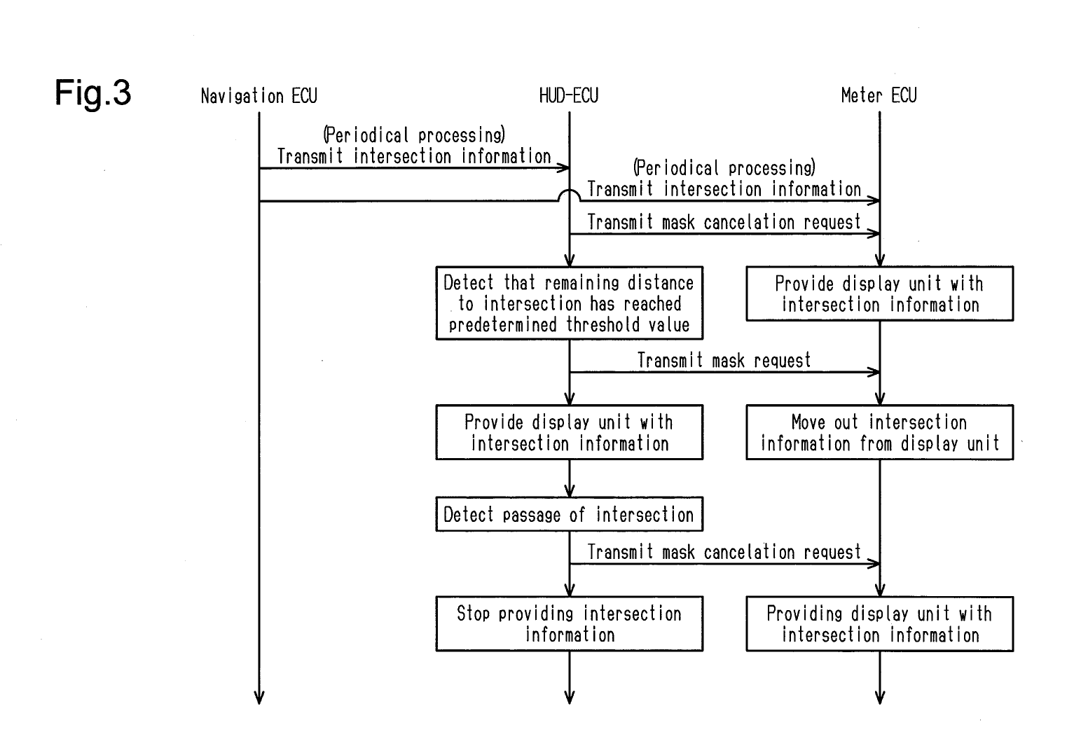

As shown in FIG. 3, the navigation ECU 110 reads the intersection information related to the next intersection from the map database 130 while detecting changes in the vehicle position with the GPS 120. The navigation ECU 110 transmits the read intersection information to the HUD-ECU 210 and the meter ECU 310 in predetermined cycles.

Further, the HUD-ECU 210 monitors the remaining distance to the next intersection based on the intersection information received from the navigation ECU 110. When the remaining distance to the next intersection is greater than the predetermined threshold value, the HUD-ECU 210 transmits the mask cancelation request to the meter ECU 310. When receiving the mask cancelation request from the HUD-ECU 210, the meter ECU 310 sends the intersection information to the display unit 320 and shows the intersection information on the display unit 320.

When detecting that the remaining distance to the next intersection has reached the predetermined threshold value, the HUD-ECU 210 transmits the mask request to the meter ECU 310. At the point in time in which the meter ECU 310 receives the mask request from the HUD-ECU 210, the meter ECU 310 moves out the display of the intersection information from the display unit 320. In this case, when transmitting the mask request to the meter ECU 310, the HUD-ECU 210 sends the intersection information to the display unit 220 and shows the intersection information on the display unit 220.

Then, when detecting that the vehicle has passed the intersection that is subject to the display of the intersection information, the HUD-ECU 210 transmits the mask cancelation request to the meter ECU 310 again. At the point in time in which the meter ECU 310 receives the mask cancelation request from the HUD-ECU 210, the meter ECU 310 sends the intersection information related to the next intersection to the display unit 320 and shows the intersection information related to the next intersection on the display unit 320. In this case, when transmitting the mask cancelation request to the meter ECU 310, the HUD-ECU 210 stops sending the intersection information to the display unit 220.

Subsequently, whenever the remaining distance to the next intersection in the traveling route set by the navigation device 100 where the vehicle turns right or left reaches the predetermined threshold value, the HUD-ECU 210 transmits the mask request to the meter ECU 310. Further, whenever the vehicle passes such an intersection, the HUD-ECU 210 stops transmitting the mask request to the meter ECU 310. In this manner, the HUD-ECU 210 gives instructions to the ECU 310 in relation with the display of the intersection information so that the HUD-ECU 210 and the meter ECU 310 cooperate to show the intersection information.

The operation of the vehicle information display system of the present embodiment will now be described.

In general, when the driver looks at the intersection information shown on the meter device 300 as the vehicle approaches an intersection, even if the head-up display 200 subsequently shows the intersection information in the display region in the line of sight of the driver, the driver continues to look at the display on the meter device 300 and does not look at the display in the line of sight. In this case, the driver continues to keep his or her eyes fixed to the display on the meter device 300 instead of looking toward the front of the vehicle. This will lower the operability of driving the vehicle.

In the present embodiment, when the remaining distance to the next intersection is relatively long, the guidance display image related to left and right turns at the intersection is shown on the display unit 320 of the meter device 300 instead of the display region of the head-up display 200. The driver can properly acknowledge the guidance display image by checking the display of the meter device 300, which the driver is likely to check periodically.

Further, in the present embodiment, at the point in time in which the remaining distance to the next intersection reaches the predetermined threshold value, the guidance display image is not shown in the display unit 320 of the meter device 300 and shown in the display region of the head-up display 200. Thus, when checking the intersection information, the driver will easily move his or her eyes to the display region of the head-up display 200, which is located in the line of sight of the driver, and does not keep his or her eyes fixed to the display unit 320 of the meter device 300. Accordingly, the driver will look at the three-dimensional guidance display image and the superimposed scenery outside the vehicle in the display region of the head-up display 200, which is located in the line of sight of the driver. This improves the operability of driving the vehicle as compared with when the eyes of the driver are fixed to the display of the meter device 300.

In particular, in the present embodiment, at the point in time in which the remaining distance to the next intersection reaches the predetermined threshold value, the guidance display image is moved from the display unit 320 of the meter device 300 to the display region of the head-up display 200 and moved out from the display unit 320 of the meter device 300. The move-out of the guidance display image allows the driver to intuitively acknowledge that the subject of the guidance display of the intersection information has moved from the meter device 300 to the head-up display 200. As a result, when checking the guidance display of the intersection information, the driver is prompted in a preferred manner to look at the display region of the head-up display 200, which is located in the line of sight of the driver.

Additionally, in the present embodiment, the head-up display 200 acts to control the cooperation of the head-up display 200 and the meter device 300 when showing the intersection information. More specifically, the head-up display 200 monitors the remaining distance to the next intersection that is included in the intersection information received from the navigation device 100. The head-up display 200 determines whether or not to transmit the mask request to the meter device 300 in accordance with whether or not the remaining distance to the next intersection has reached the predetermined threshold value. The meter device 300 moves out the intersection information in accordance with a mask request from the head-up display 200 without acknowledging the remaining distance to the next intersection. This reduces the processing load on the meter device 300 as compared with when the meter device 300 acts as the subject that monitors the remaining distance to the next intersection. As a result, the meter device 300 shows information that is particularly necessary when driving the vehicle, for example, the vehicle speed in real time, with high reliability.

As described above, the present embodiment has the advantages described below.

(1) When the distance from the vehicle to the intersection is greater than the predetermined threshold value, the intersection information is shown on the display unit 320 of the meter device 300 instead of the display region of the head-up display 200. Thus, when checking the intersection information, the driver looks at the display unit 320 of the meter device 300. At the point in time in which the distance from the vehicle to the intersection reaches the predetermined threshold value, the intersection information is moved to the display unit 320 of the meter device 300 from the display region of the head-up display 200 and moved out from the display region of the meter device 300. The move-out of the intersection information allows the driver to intuitively acknowledge that the subject of display of the intersection information has moved from the meter device 300 to the head-up display 200. Thus, the eyes of the driver are guided toward the front of the vehicle and the display region of the head-up display 200. This allows the driver to check the intersection information together with the outer situation of the vehicle without looking away from the front of the vehicle. Accordingly, when the vehicle approaches the intersection, the intersection information is shown to the driver while maintaining the operability of driving the vehicle.

(2) When the distance from the vehicle to the intersection, which is subject to display, is greater than the predetermined threshold value, the information related to a vehicle state that needs to be periodically checked by the driver when driving the vehicle is shown on the meter device 300 together with the intersection information. This allows the driver to check the intersection information properly shown on the meter device 300. Further, the driver periodically looks at the meter device 300 when driving the vehicle and can thus properly recognize the move-out of the intersection information from on the meter device 300. This allows the driver to quickly acknowledge that the subject of display of the intersection information has moved from the meter device 300 to the head-up display 200. Thus, the intersection information is shown to the driver in a further preferred manner while maintaining the operability of driving the vehicle.

(3) The head-up display 200 functions to control the cooperation of the head-up display 200 and the meter device 300 when showing the intersection information and when not showing the intersection information. This reduces the processing load on the meter device 300 that serves as the subject mainly showing the information that is particularly necessary when driving the vehicle, for example, the vehicle speed. Accordingly, the meter device 300 can continue to show information with high reliability in real time.

(4) The intersection information shown by the meter device 300 and the intersection information shown by the head-up display 200 include a common image. This increases the uniformity of the display of the intersection information. Thus, the head-up display 200 and the meter device 300 cooperate to show the intersection information in a further preferred manner.

It should be apparent to those skilled in the art that the present invention may be embodied in many other specific forms without departing from the spirit or scope of the invention. Particularly, it should be understood that the present invention may be embodied in the following forms.

In the above embodiment, the display of the guidance display image is switched between the head-up display 200 and the meter device 300 at the point in time in which the remaining distance to the next intersection reaches the predetermined threshold value. However, the predetermined threshold value does not need to be fixed and may be varied immediately after the vehicle has passed an intersection in accordance with the remaining distance to the next intersection. More specifically, immediately after the vehicle has passed an intersection, when the remaining distance to the next intersection is less than a reference distance (for example, 700 m), a first value (for example, 150 m) may be set as the predetermined threshold value. When the remaining distance is greater than or equal to the reference distance, a second value (for example, 450 m) that is greater than the first value may be set as the predetermined threshold value.

In the above embodiment, the head-up display 200 and the meter device 300 provide the corresponding display units 220 and 320 with the guidance display image included in the intersection information transmitted from the navigation device 100 and display the guidance display image on the corresponding display units 220 and 320. However, the intersection information transmitted from the navigation device 100 does not need to include the guidance display image. For example, the head-up display 200 and the meter device 300 may each store the guidance display image in a corresponding memory in advance and read the guidance display image in accordance with the remaining distance to the next intersection. In this case, the head-up display 200 and the meter device 300 may show a common guidance display images or different guidance display images. Nevertheless, it is preferred that the head-up display 200 and the meter device 300 show a common guidance display image when the head-up display 200 and the meter device 300 cooperate to show the intersection information.

In the above embodiment, the head-up display 200 serves to control cooperation of the head-up display 200 and the meter device 300 to show the intersection information. However, as long as the processing capability of the meter device 300 is ensured, the meter device 300 may serve to control cooperation of the head-up display 200 and the meter device 300 to show the intersection information. Alternatively, each of the head-up display 200 and the meter device 300 may serve to control cooperation of the head-up display 200 and the meter device 300 to show the intersection information. In this case, each of the head-up display 200 and the meter device 300 may determine whether or not to show the intersection information in accordance with the remaining distance to the next intersection included in the intersection information transmitted from the navigation device 100. As another option, the navigation device 100 may serve to control cooperation of the head-up display 200 and the meter device 300 to show the intersection information. In this case, the navigation device 100 determines whether or not the remaining distance to the next intersection has reached the predetermined threshold value. When the remaining distance to the next intersection has not reached the predetermined threshold value and until the remaining distance reaches the predetermined threshold value, the navigation device 100 requests the meter device 300 to show the intersection information. When the remaining distance to the next intersection has reached the predetermined threshold value, the navigation device 100 requests the meter device 300 to move out the intersection information. When the remaining distance to the next intersection is less than the predetermined threshold value, the navigation device 100 requests the head-up display 200 to show the intersection information.

In the above embodiment, the head-up display 200 transmits the mask request or the mask cancelation request so that the head-up display 200 and the meter device 300 cooperate to show the intersection information. Alternatively, the head-up display 200 does not need to transmit the mask cancelation request and may transmit only the mask request to the meter device 300. In this case, the meter device 300 can switch the display of the intersection information in accordance with whether or not the head-up display 200 has transmitted the mask request.

In the above embodiment, among the intersections in the searched traveling route, the intersection closest to the vehicle is subject to the display of the intersection information. However, the display subject of the intersection information is not necessarily limited to the intersections in the searched traveling route. For example, the subject of display can be specified based on the position and the traveling direction of the vehicle, and an intersection toward which the vehicle is heading can be subject to the display of the intersection information.

In the above embodiment, the head-up display 200 obtains information related to the remaining distance to the next intersection based on the intersection information received from the navigation device 100. However, the head-up display 200 does not necessarily have to obtain the intersection information from the navigation device 100 and may obtain the intersection information, for example, from outside the vehicle via an on-board communication unit.

In the above embodiment, the display device with which the head-up display 200 cooperates to show the intersection information is the meter device 300. However, such a display device may be, for example, the navigation device 100 or a mobile information terminal carried by an occupant of the vehicle.

Each of the navigation ECU 110, the HUD-ECU 210, and the meter ECU 310 may include, for example, circuitry that includes, for example, (1) at least one dedicated hardware circuit such as an application-specific integrated circuit (ASIC), (2) at least one processing circuit that operates according to a computer program (software), or (3) a combination of these. The processing circuit includes a CPU and memories (ROM, RAM, and the like), which store programs executed by the CPU. The memories, or computer readable media, include any type of media that are accessible by general-purpose computers and dedicated computers.

The present examples and embodiments are to be considered as illustrative and not restrictive, and the invention is not to be limited to the details given herein, but may be modified within the scope and equivalence of the appended claims.

1. A vehicle information display system configured to show a driver intersection information related to an intersection toward which a vehicle is heading, the vehicle information display system comprising:
a head-up display configured to show the intersection information in a first display region located in a line of sight of the driver when a distance from the vehicle to the intersection is less than a predetermined threshold value; and
a display device configured to show the intersection information in a second display region, which differs from the first display region, when the distance from the vehicle to the intersection is greater than the predetermined threshold value and until the distance reaches the predetermined threshold value,
wherein the display device is configured so that when the distance from the vehicle to the intersection reaches the predetermined threshold value, the display device moves display of the intersection information in the second display region to the first display region and moves out the display of the intersection information from the second display region.

2. The vehicle information display system according to claim 1, wherein the display device is a meter device configured to show information related to a vehicle state.

3. The vehicle information display system according to claim 2, wherein
the head-up display is configured to request the meter device to move out the display of the intersection information from the second display region when the distance from the vehicle to the intersection reaches the predetermined threshold value, and
the meter device is configured to move out the display of the intersection information in accordance with the request from the head-up display.

4. The vehicle information display system according to claim 3, wherein the head-up display is configured so that when the vehicle passes the intersection, the head-up display stops showing the intersection information in the first display region and cancels the request to the meter device.

5. The vehicle information display system according to claim 2, wherein
the head-up display and the meter device are each configured to receive the intersection information from a navigation device and show the received intersection information, and
the intersection information received by the head-up display and the intersection information received by the meter device include a common image.

6. A method for displaying vehicle information that shows a driver intersection information related to an intersection toward which a vehicle is heading, the method comprising:
showing the intersection information in a first display region of a display device when a distance from the vehicle to the intersection is greater than a predetermined threshold value and until the distance reaches the predetermined threshold value;
moving out display of the intersection information from the first display region when the distance from the vehicle to the intersection reaches the predetermined threshold value by moving the display of the intersection information in the first display region to a second display region of a head-up display located in a line of sight of a driver; and
showing the intersection information in the second display region when the distance from the vehicle to the intersection is less than the predetermined threshold value.

7. The method according to claim 6, wherein
the display device is a meter device that shows information related to a vehicle state,
the showing the intersection information in the first display region of the display device includes the head-up display requesting the meter device to show the intersection information, and
the moving out the display of the intersection information from the first display region includes the head-up display requesting the meter device to move out the display of the intersection information at a point in time in which the distance from where the vehicle is located to the intersection where intersection information is shown reaches the predetermined threshold value so that the meter device starts moving out the display of the intersection information in accordance with the move-out request and the head-up display starts showing the intersection information.
